(19) United States
(12) Patent Application Publication
(10) Pub. No.: US 2014/0013256 A1
(43) Pub. Date: Jan. 9, 2014

(54) METHOD AND SYSTEM FOR DYNAMIC MODIFICATION OF DESKTOP LAYOUT AND COMPUTER STORAGE MEDIUM THEREOF

(71) Applicant: TENCENT TECHNOLOGY (SHENZHEN) COMPANY LIMITED, Shenzhen (CN)

(72) Inventors: Xin Wan, Shenzhen (CN); Bin Ma, Shenzhen (CN); Xun Ding, Shenzhen (CN); Wen Zhang, Shenzhen (CN); Guitang Zhu, Shenzhen (CN)

(73) Assignee: TENCENT TECHNOLOGY (SHENZHEN) COMPANY LIMITED, Shenzhen (CN)

(21) Appl. No.: 14/022,958

(22) Filed: Sep. 10, 2013

Related U.S. Application Data
(63) Continuation-in-part of application No. PCT/CN2012/070867, filed on Feb. 3, 2012.

(30) Foreign Application Priority Data
Mar. 10, 2011 (CN) 201110057154.0

(51) Int. Cl. G06F 3/0481

(52) U.S. Cl. CPC G06F 3/0481
USPC 715/765

(57) ABSTRACT

The present disclosure relates to a method and system dynamic modification of desktop layout and a computer storage medium thereof. The method includes: obtaining desktop elements; placing the desktop elements on the desktop area; receiving requests for modifying the desktop elements; and modifying the desktop elements according to the requests for modification. The method and system for dynamic modification of desktop layout and computer storage medium thereof could modify desktop elements according to requests for modifying desktop elements; the desktop elements could be elastically modified to meet different demands.

### CROSS-REFERENCE TO RELATED APPLICATIONS

This application is a continuation-in-part (CIP) of International Application PCT/CN2012/070867, filed Feb. 3, 2012, which claims priority to Chinese application CN 201110057154.0 filed Mar. 10, 2011, which are incorporated herein by reference in their entireties.

### FIELD OF THE INVENTION

The present disclosure relates generally to the field of computer technology, and more particularly, to a method and system for dynamic modification of desktop layout, and computer storage medium thereof.

### BACKGROUND OF THE INVENTION

Web instant communication tools (Instant Messaging, IM) have become acceptable and essential tools for internet users along with its development. They have been widely used not only in people's leisure and entertainment, but also in their workings. As a result, there have been rising high demands for the accessibility, stability, and security for the instant messaging tools. A desktop system is a kind of common system architecture for computer users. A conventional desktop system is composed of preset static elements; therefore the elements on the desktop could not be modified according to user demands.

### SUMMARY OF THE INVENTION

Accordingly, it is necessary to provide a method for dynamic modification of desktop layout that could elastically modify the desktop elements.

A method for dynamic modification of desktop layout includes steps of:

obtaining desktop elements;

placing the desktop elements on a desktop area;

receiving requests for modifying the desktop elements; and

modifying the desktop elements according to the requests for modification.

Besides, it is necessary to provide a system for dynamic modification of desktop layout that could elastically modify the desktop elements.

A system for dynamic modification of desktop layout includes:

an obtain module for obtaining desktop elements;

a layout module for placing the desktop elements on a desktop area;

a request receive module for receiving requests for modifying the desktop elements; and

a refresh module for modifying the desktop elements according to the requests for modification.

Besides, it is necessary to provide a computer storage medium for dynamic modification of desktop layout that could elastically modify the desktop elements.

At least one non-transitory computer storage medium having computer-executive instructions stored thereon, wherein the computer-executive instructions are used for executing a method for dynamic modification of desktop layout, wherein the method comprises:

obtaining desktop elements;

placing the desktop elements on a desktop area;

receiving requests for modifying the desktop elements; and

modifying the desktop elements according to the requests for modification.

The method and system for dynamic modification of desktop layout and computer storage medium thereof could modify desktop elements according to requests for modifying desktop elements; the desktop elements could be elastically modified to meet different demands.

### BRIEF DESCRIPTION OF THE DRAWINGS

FIG. 1 is a flow chart of a method for dynamic modification of desktop layout according to one embodiment of the present disclosure;

FIG. 2 is a flow chart of a method for dynamic modification of desktop layout according to another embodiment of the present disclosure;

FIG. 3 is a conceptual illustration of an interface of dynamic modification of desktop layout according to an embodiment;

FIG. 4 is a flow chart of the method for dynamic modification of desktop layout according to a request for modification of FIG. 2;

FIG. 5 is a flow chart of the method for placing the desktop components on the rolling area of FIG. 4;

FIG. 6 is a block diagram of a system for dynamic modification of desktop layout according to an embodiment;

FIG. 7 is a block diagram of a system for dynamic modification of desktop layout according to another embodiment;

FIG. 8 is a block diagram of the internal structure of the refresh module of FIG. 7; and

FIG. 9 is a diagram of a computing system on which various embodiments of the invention may be executed.

### DESCRIPTION OF THE PREFERRED EMBODIMENTS

Following are detailed descriptions of the present disclosure with reference to the embodiment and the enclosed drawings.

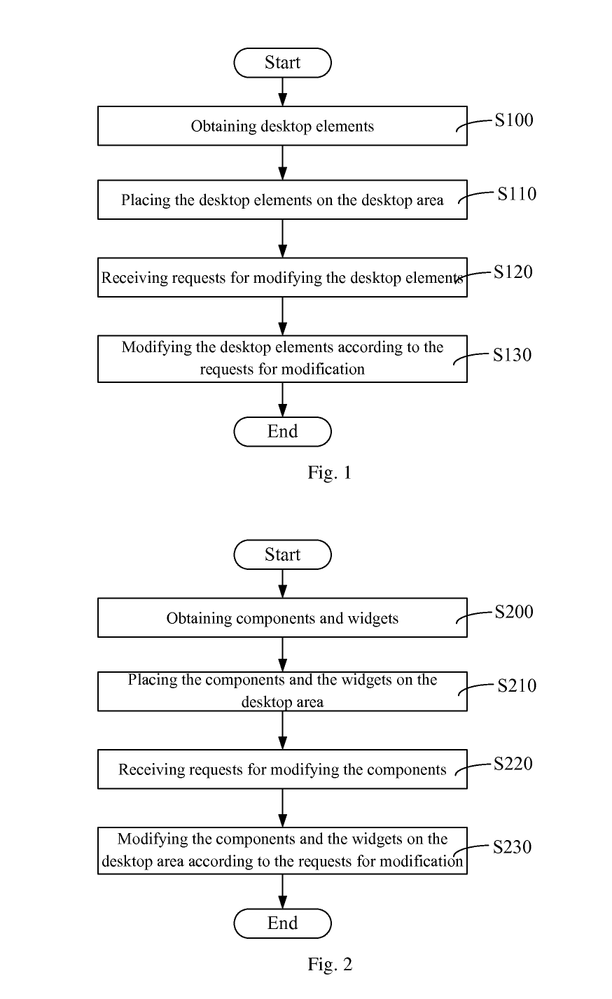

Referring to FIG. 1, in accordance with an embodiment, a method for dynamic modification of desktop layout includes the following steps:

Step S100, obtaining desktop elements.

The desktop elements may include components and widgets. The widgets are GUI widgets that include, but not limited to, press buttons, drop down lists, text boxes, tables, etc.

Step S110, placing the desktop elements on a desktop area.

Place the obtained desktop elements on the desktop area for demonstration.

Step S120, receiving requests for modifying the desktop elements.

Modification of the desktop elements could be adding the desktop elements, deleting the desktop elements or adjusting the size of the desktop elements, etc.

Step S130, modifying the desktop elements according to the requests for modification.

Executing operations corresponding to the requests for modification, for example, creating a desktop element and adding the created desktop element to the desktop area if requested for adding desktop elements; or directly deleting chosen desktop element if requested for deleting desktop elements; or zooming in or out the chosen desktop element if requested for adjusting the size of the desktop elements.

Referring to FIG. 2, according to another embodiment, if the desktop elements include components and widgets, a method for dynamic modification of desktop layout include in detail the following steps:

Step S200, obtaining components and widgets.

After launched by the user, the system obtains stored components and widgets; if the system is launched for the first time, default components and widgets are obtained.

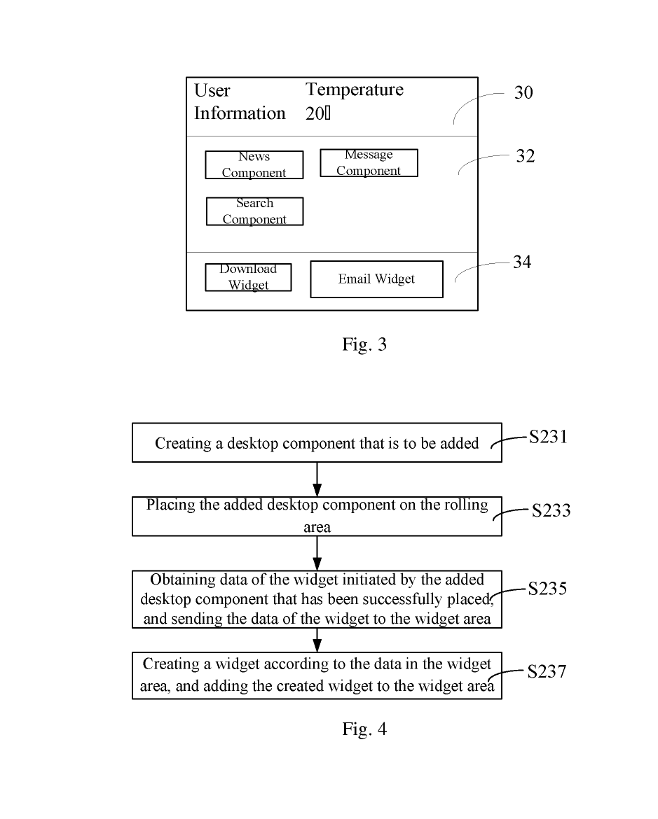

It is further included before step S200 that, distinguishing the desktop area into a component area and a widget area. The component area includes an information area and a rolling area. The components include information components and desktop components. The component area is an area for placing information components, as the desktop rolls, such area remains unchanged; the rolling area is an area for placing the desktop components and may includes several pages that could be transversely rolled to switch for displaying the required page if the amount of the pages are more than one. The widget area is an area for placing the widgets, when the desktop rolls, this area remain unchanged. The information components are components to be placed in the information area, they may exist as only one and when placed on the desktop, several widgets could be added in the widget area, such as user information and weather, to collectively form an information component. The desktop components are components to be placed in the rolling area, they may exist as multiple and when placed on the desktop, several widgets could be added in the widget area, such as news and messages, are desktop components. Referring to FIG. 3, the information area 30 is placed with components composed of user information and weather; the rolling area 32 is placed with a news component, a message component, and a search component; the widget area 34 is placed with a download widget, an email widget, etc.

Step S210, placing the components and the widgets on the desktop area.

After obtaining the stored components and widgets, place the components and the widgets on the desktop area. Place the information components directly on the information area; place the stored desktop components in a specified position on a specified page in the rolling area; and place the widgets on the widget area.

Step S220, receiving requests for modifying the components.

The modification of the components could be adding components, deleting components, or adjusting the size of the components.

Step S230, modifying the components and the widgets on the desktop area according to the requests for modification.

Directly delete if the request for modifying the components is to delete the component.

If the request for modifying the components is to add the component, there could be two kinds: adding the information component and adding the desktop component.

According to one embodiment, when the request for modifying component is to add an information component on the desktop area, create an information component that is to be added and place the created information component directly to the information area. As the information area shall be place with only one information component, the added information component will replace the previously placed information component.

According to an embodiment, referring to FIG. 4, when the request for modifying the component is to add a desktop component on the desktop area, the steps for modifying the components and widgets on the desktop area according to the request for modifying the components include in detail:

Step S231, creating a desktop component that is to be added.

Create a desktop component, and obtains the data of the desktop component, such as the size of the component, etc.

Step S233, placing the added desktop component on the rolling area.

Automatically search for a position for placing the desktop component in the rolling area starting from the current page. If the position is found, place the desktop component in the found position; otherwise search in the next page for the position, and so on.

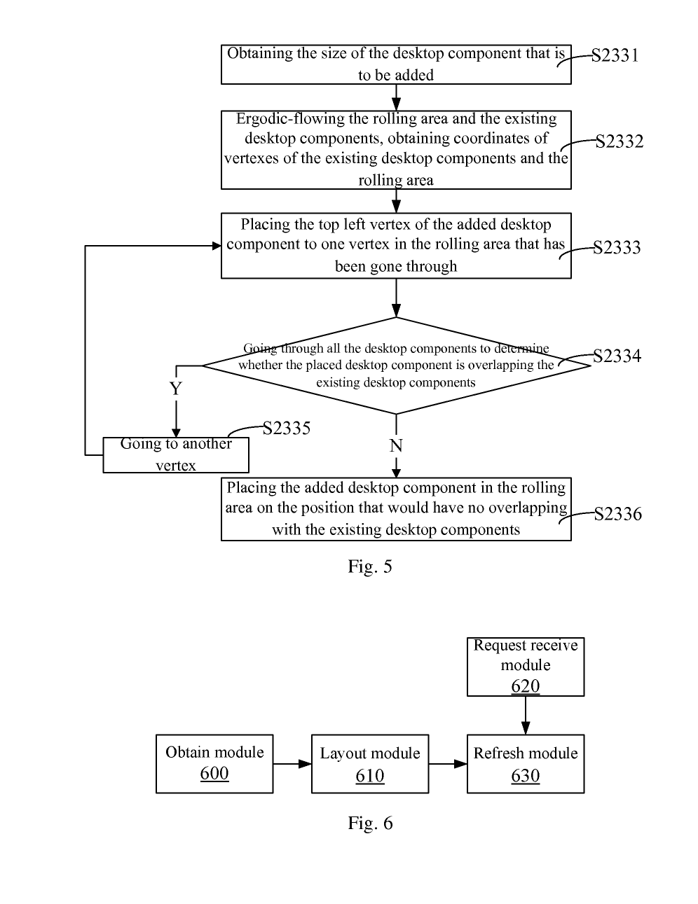

According to an embodiment, referring to FIG. 5, step S233 could include in detail:

Step S2331, obtaining the size of the desktop component that is to be added.

The desktop component would display in form of a rectangular frame. The size of the rectangular frame of the desktop component that is to be added is firstly obtained, for a follow-up determination of whether it could be place on the rolling area.

Step S2332, travelling the rolling area and the existing desktop components, obtaining coordinates of vertexes of the existing desktop components and the rolling area.

Obtaining coordinates of the four vertexes of the rectangular frame of the rolling area, and coordinates of the four vertexes of the rectangular frame of the existing desktop components in the rolling area.

After coordinates of the vertexes of the existing desktop components and the rolling area are obtained, the coordinates of the vertexes could further be filtered to preclude positions that are apparently unable to be placed with the added desktop component. Such positions include top left vertexes of the existing desktop components, top right vertexes, bottom left vertexes, and bottom right vertexes of the rolling area. As the rolling area and the desktop component is displayed before users, the rolling area and the desktop component respectively has four vertexes, the top left vertex, the top right vertex, the bottom left vertex, and the bottom right vertex.

Step S2333, placing the top left vertex of the added desktop component to one vertex in the rolling area that has been gone through.

Step S2334, travelling all the desktop components to determine whether the placed desktop component is overlapping the existing desktop components. If there is any overlapping, go to step S2335, or go to step S2336 if no.

Step S2335, going to another vertex and jump to step S2333.

Step S2336, placing the added desktop component in the rolling area on the position that would have no overlapping with the existing desktop components.

In case that the top left vertex of the added desktop component is placed on all of the vertexes in the rolling area and is found overlapping with the existing desktop components, the added desktop component could not be place in the rolling area and a reminder of failure for placing is released.

Step S235, obtaining data of the widget initiated by the added desktop component that has been successfully placed, and sending the data of the widget to the widget area.

After the desktop component is successfully placed, obtain the data of the widget initiated by the added desktop component. Such data may include the icon of the widget, the size of the widget, the logic to be executed after being clicked, etc. The data is then sent to the widget area.

Step S237, creating a widget according to the data in the widget area, and adding the created widget to the widget area.

Create a widget in the widget area according to the data of the widget, and add the created widget into the widget area. For example, if the added desktop component is a component for playing music, the widget of play, pause, fast forward, rewind could be added in the widget area.

If the request for modifying the component is to adjusting the size of the components, place the component which size has been adjusted into the rolling area, the detailed placing steps could be referred to step S2331 to step S2336.

Besides, it is provided by the present disclosure one or more computer storage medium that contain computer executable instructions. Such computer executable instructions are used for executing a method for dynamic modification of desktop layout. The detailed steps of the method for dynamic modification of desktop layout executed by the computer executable instructions contained in the computer storage medium is as described in the above method, and would not be described more.

According to an embodiment, referring to FIG. 6, a system for dynamic modification of desktop layout, includes an obtain module 600, a layout module 610, a request receive module 620 and a refresh module 630.

The obtain module 600 is used for obtaining the desktop elements. The desktop elements may include components and widgets. The widgets are GUI widgets that include, but not limited to, press buttons, drop down lists, text boxes, tables, etc.

The layout module 610 is used for placing the desktop elements on a desktop area. The layout module 610 places the obtained desktop elements on the desktop area for demonstration.

The request receive module 620 is used for receiving requests for modifying the desktop elements. Modification of the desktop elements could be adding the desktop elements, deleting the desktop elements or adjusting the size of the desktop elements, etc.

The refresh module 630 is used for modifying the desktop elements according to the requests for modification. The refresh module 630 executes operations corresponding to the requests for modification, for example, the refresh module 630 creates a desktop element and adds the created desktop element to the desktop area if requested for adding desktop elements; or the refresh module 630 directly deletes chosen desktop element if requested for deleting desktop elements; or the refresh module 630 zooms in or out the chosen desktop element if requested for adjusting the size of the desktop elements.

According to another embodiment, take an example that the desktop element includes components and widgets, the working principles of the system for dynamic modification of desktop layout includes the followings.

The obtain module 600 is used for obtaining components and widgets. After the system is launched by the used, the obtain module 600 obtains stored components and widgets; if the system is launched for the first time, default components and widgets are obtained by the obtain module 600.

The layout module 610 is used for placing the components and the widgets on the desktop area. The components include information components and desktop components. The user information and weather collectively form an information component; the desktop components could be news components, message components, and search components, etc; the widgets could be download widgets, email widgets, etc.

The request receive module 620 is used for receiving requests for modifying the components. The modification of the components could be adding components, deleting components, or adjusting the size of the components.

The refresh module 630 is used for modifying the components and the widgets on the desktop area according to the requests for modification.

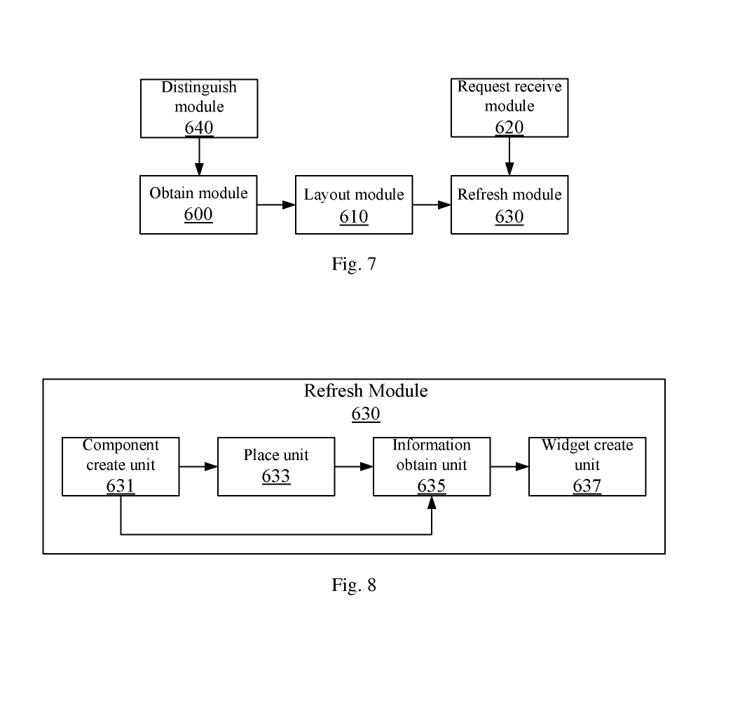

According to an embodiment, referring to FIG. 7, the above system for dynamic modification of desktop layout includes not only the obtain module 600, the layout module 610, the request receive module 620 and the refresh module 630, but also the distinguish module 640.

The distinguish module 640 is used for distinguishing the desktop area into a component area and a widget area. The layout module 610 is further used for placing the components on the component area, and placing the widgets on the widget area.

In the embodiment, the component area includes an information area and a rolling area. The components include information components and desktop components. The component area is an area for placing information components, as the desktop rolls, such area remains unchanged; the rolling area is an area for placing the desktop components and may includes several pages that could be transversely rolled to switch for displaying the required page if the amount of the pages are more than one. The widget area is an area for placing the widgets, when the desktop rolls, this area remain unchanged. The information components are components to be placed in the information area, they may exist as only one and when placed on the desktop, several widgets could be added in the widget area, such as user information and weather, to collectively form an information component. The desktop components are components to be placed in the rolling area, they may exist as multiple and when placed on the desktop, several widgets could be added in the widget area, such as news and message, is a desktop component.

The layout module 610 is further used for placing the information components on the information area, and placing the desktop components on the rolling area.

When the desktop component is stored desktop components, the layout module is further used for placing the stored desktop components in a specified position on a specified page in the rolling area.

According to one embodiment, referring to FIG. 8, when the request for modification that the request receive module 620 has received is to add a desktop component on the desktop area, the refresh module 630 include a component create unit 631, a place unit 633, an information obtain unit 635 and a widget create unit 637.

The component create unit 631 is used for creating the desktop component that is to be added. The component create unit 631 creates a desktop component, and obtains the data of the desktop component, such as the size of the component, etc.

The place unit 633 is used for placing the added desktop component on the rolling area. The place unit 633 automatically searches for a position for placing the desktop component in the rolling area starting from the current page. If the position is found, place the desktop component in the found position; otherwise search in the next page for the position, and so on.

In a preferred embodiment, the process that the place unit 633 places the added desktop components on the rolling area in details includes:

(1) Obtaining the size of the desktop component that is to be added. The desktop component would display in form of a rectangular frame. The size of the rectangular frame of the desktop component that is to be added is firstly obtained, for a follow-up determination of whether it could be place on the rolling area.

(2) Travelling the rolling area and the existing desktop components, obtaining coordinates of vertexes of the existing desktop components and the rolling area.

Obtaining coordinates of the four vertexes of the rectangular frame of the rolling area, and coordinates of the four vertexes of the rectangular frame of the existing desktop components in the rolling area.

After coordinates of the vertexes of the existing desktop components and the rolling area are obtained, the coordinates of the vertexes could further be filtered to preclude positions that are apparently unable to be placed with the added desktop component. Such positions include top left vertexes of the existing desktop components, top right vertexes, bottom left vertexes, and bottom right vertexes of the rolling area. As the rolling area and the desktop component is displayed before users, the rolling area and the desktop component respectively has four vertexes, the top left vertex, the top right vertex, the bottom left vertex, and the bottom right vertex.

(3) Placing the top left vertex of the added desktop component to one vertex in the rolling area that has been gone through.

(4) Travelling all the desktop components to determine whether the placed desktop component is overlapping the existing desktop components. If there is any overlapping, go to process (5), or go to process (6) if no.

(5) Going to another vertex and jump to process (3).

(6) Placing the added desktop component in the rolling area on the position that would have no overlapping with the existing desktop components.

In case that the top left vertex of the added desktop component is placed on all of the vertexes in the rolling area and is found overlapping with the existing desktop components, the added desktop component could not be place in the rolling area and a reminder of failure for placing is released.

According to an embodiment, if the request that the request receive module 620 has received is to adjust the size of the components, the refresh module 630 is used for placing the component that size has been adjusted on the rolling area, the process for placing is as process (1) to (6) in detail.

The information obtain unit 635 is used for obtaining data of the widget initiated by the added desktop component that has been successfully placed, and sending the data of the widget to the widget area. Such data may include the icon of the widget, the size of the widget, the logic to be executed after being clicked, etc. The data is then sent to the widget area.

The widget create unit 637 is used for creating a widget according to the data in the widget area, and adding the created widget to the widget area. The widget create unit 637 creates a widget in the widget area according to the data of the widget, and adds the created widget into the widget area. For example, if the added desktop component is a component for playing music, the widget of play, pause, fast forward, rewind could be added in the widget area.

The method and system for dynamic modification of desktop layout and computer storage medium thereof could modify desktop elements according to requests for modifying desktop elements; the desktop elements could be elastically modified to meet different demands.

Besides, distinguishing the desktop area into the information area, the rolling area and the widget area could facilitate in modifying only within the rolling area instead of modifying the whole desktop area.

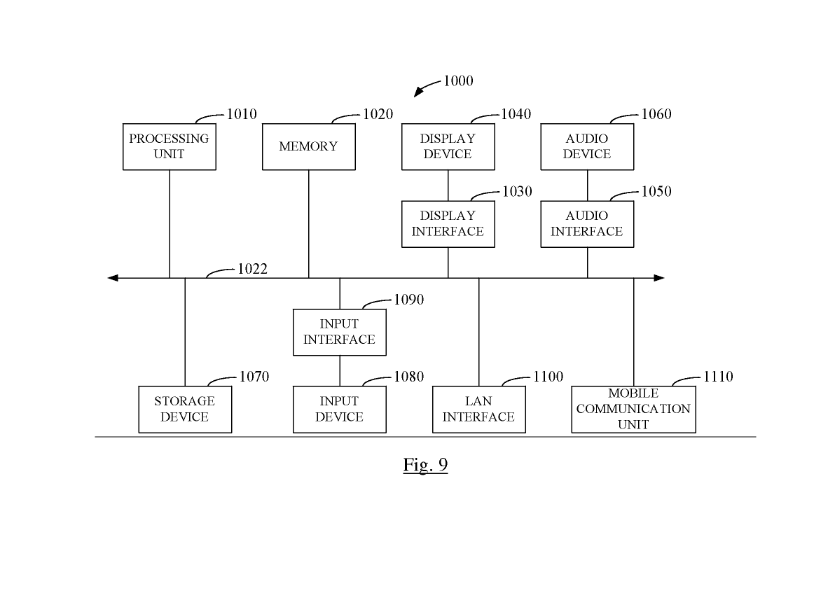

FIG. 9 shows a system block diagram of a computing system 1000 on which embodiments of the invention may be implemented. The computing system 1000 is only one example of a suitable computing environment and is not intended to suggest any limitation as to the scope of use or functionality of embodiments of the invention. Neither should the computing system 1000 be interpreted as having any dependency or requirement relating to any one or combination of components illustrated in the exemplary computing system 1000.

The computing system 1000 shown in FIG. 9 is an example of a computer system suitable for use with the invention. Other architectures having different configurations of subsystems can also be utilized. Examples of well known computer systems may be suitable for use with embodiments of the invention include, but are not limited to, desktop computers, laptop computers, personal digital assistants, smart phones, tablet computers, portable media players, set top boxes, and the like.

As in FIG. 9, an exemplary system for implementing embodiments of the invention includes a general purpose computing device in the form of the computing system 1000. The computing system 1000 includes a processing unit 1010, a memory 1020, and a system bus 1022 that couples various system components including the memory 1020 to the processing unit 1010. The processing unit 1010 is a hardware that carries out the instructions of a computer program by performing the basic arithmetical and logical operations of the computer system. The memory 1020 is a physical device used to store computer program or data (e.g. program state information) on a temporary or permanent basis. The system bus 1022 may be any of several types of bus structures including a memory bus or memory controller, a peripheral bus, and a local bus. The system bus 1022 allows data communication between the processing unit 1010 and the memory 1020, which may include read-only memory (ROM) or flash memory (neither shown), and random access memory (RAM) (not shown). The RAM is generally the main memory into which the operating system and application programs are loaded.

The computing system 1000 further includes a display interface 1030 (e.g., graphic processing unit), a display device 1040 (e.g., liquid crystal display device), an audio interface 1050 (e.g., sound card), and an audio device 1060 (e.g., speaker). The display device 1040 and the audio device 1060 are media devices used to experience multimedia content.

The computing system 1000 typically includes a storage device 1070. The storage device 1070 may be selected from a variety of computer readable media. The computer readable media can be any available media that can be accessed by the computing system 1000 and includes both removable and non-removable media. By way of example, computer readable media includes, but is not limited to, flash memory (e.g., micro SD card), CD-ROM, digital versatile disks (DVD) or other optical disk storage, magnetic cassettes, magnetic tape, magnetic disk storage or other magnetic storage devices, or any other medium which can be used to store the desired information and which can accessed by the computing system 1000.

The computing system 1000 further includes an input device 1080 and an input interface 1090 (e.g., IO controller). A user may enter commands and information into the computing system 1000 through the input device 1080 such as a keyboard, a mouse, a touch panel disposed on the display device 1040. The input device 1080 is often connected to the processing unit 1010 through the input interface 1090 that is coupled to the system bus 1022, but may be connected by other interface and bus structures, such as a universal serial bus (USB).

The computing system 1000 may operate in a networked environment using logical connections to one or more network devices. The network device may be a personal computer, a server, a router, a smart phone, a tablet computer or other common network node. The computing system 1000 connects the network device via a local area network (LAN) interface 1100 or a mobile communication unit 1110. A local area network (LAN) is a computer network that interconnects computers in a limited area such as a home, school, computer laboratory, or office building using network media. Ethernet over twisted pair cabling, and WiFi are the two most common technologies currently used to build LANs. WiFi is a technology that allows the computing system 1000 to exchange data or connect to the internet wirelessly using radio waves. The mobile communication unit 1110 can make and receive telephone calls over a radio link while moving around a wide geographic area. In addition to telephony, the mobile communication unit 1110 also supports internet access by providing mobile data service on the 2G, 3G, or 4G cellular communication system.

It should be noted that, in other computing systems suitable for use with the invention, the computing system may include additional or fewer subsystems. For example, another computing system could include a Bluetooth unit for exchanging data over short distances, an image sensor for photography, and an accelerometer for measuring acceleration.

As described in detail above, the computing system 1000, consistent with the present invention, perform certain operations for dynamic modification of desktop layout. The computing system 1000 may perform these operations in response to the processing unit 1010 executing software instructions contained in a computer storage medium. The software instructions may be read into the memory 1020 from the storage device 1070, or from another device via the LAN interface 1100. The software instructions contained in the memory 1020 causes the processing unit 1010 to perform the method for dynamic modification of desktop layout described above. Alternatively, hardwired circuitry may be used in place of or in combination with software instructions to implement processes consistent with the present invention. Thus, the present invention is not limited to any specific combination of hardware circuitry and software.

The above described embodiments explains only several exemplary embodiments of the present disclosure; the descriptions are specified and detailed, while shall not be understood as to limit the invention to the precise forms disclosed. It shall be mentioned that for those skilled in the art, alternative embodiments could be made to which the present disclosure pertains without departing from its spirit and scope. Accordingly, the scope of the present disclosure is defined by the appended claims rather than the foregoing description and the exemplary embodiments described therein.

What is claimed is:

1. A method for dynamic modification of a desktop layout, comprising:
obtaining desktop elements;
placing the desktop elements on a desktop area;
receiving requests for modifying the desktop elements on the desktop area; and
modifying the desktop elements on the desktop area according to the requests for modifying.

2. The method for dynamic modification of a desktop layout according to claim 1, wherein the desktop elements comprise components and widgets, the method further comprising:
obtaining the components and widgets;
placing the components and the widgets on the desktop area;
receiving requests for modifying the components on the desktop area;
modifying the components and the widgets on the desktop area according to the received requests for modifying.

3. The method for dynamic modification of a desktop layout according to claim 2, wherein:
before the step of obtaining the components and the widgets, the method comprises distinguishing the desktop area into a component area and a widget area, wherein the component area comprises an information area and a rolling area, the components comprise information components and desktop components; and
the step of placing the components and the widgets on the desktop area comprises: placing the information components on the information area, placing the desktop components in the rolling area, and placing the widgets on the widget area.

4. The method for dynamic modification of a desktop layout according to claim 3, wherein:
the desktop components are stored desktop components, and
the step of placing the components and the widgets on the desktop area comprises placing the stored desktop components in a specified position on a specified page in the rolling area.

5. The method for dynamic modification of a desktop layout according to claim 3, wherein when the requests for modifying the components include a request to add a desktop component on the desktop area, the step of modifying the components and the widgets on the desktop area comprises:
creating a desktop component that is to be added;
placing the added desktop component on the rolling area;
obtaining data of a widget initiated by the added desktop component that has been successfully placed, and sending data of the widget initiated by the added desktop component to the widget area; and
creating a widget according to the data in the widget area, and adding the created widget to the widget area.

6. The method for dynamic modification of a desktop layout according to claim 5, wherein the step of placing the added desktop component on the rolling area comprises: obtaining a size of the desktop component that is to be added;
travelling the rolling area and existing desktop components, obtaining coordinates of vertexes of the existing desktop components and the rolling area;
placing a top left vertex of the added desktop component to a respective vertex in the rolling area that has been gone through; and
travelling all the desktop components to determine whether the placed desktop component is overlapping the existing desktop components, travelling another vertex if the placed desktop component is determined to overlap the existing desktop components, and placing the added desktop component in the rolling area on a position that would have no overlapping with the existing desktop components if the placed desktop component is determined to not overlap with the existing desktop.

7. A system for dynamic modification of a desktop layout, comprising:
an obtain module configured to obtain desktop elements;
a layout module configured to place the desktop elements on a desktop area;
a request receive module configured to receive requests for modifying the desktop elements on the desktop area; and
a refresh module configured to modify the desktop elements on the desktop area according to the received requests for modifying.

8. The system for dynamic modification of a desktop layout according to claim 7, wherein
the desktop elements comprise components and widgets;
the obtain module is further configured to obtain components and widgets;
the layout module is further configured to place the components and the widgets on the desktop area;
the request receive module is further configured to receive requests for modifying the components on the desktop area; and
the refresh module is further configured to modify the components and the widgets on the desktop area according to the received requests for modification.

9. The system for dynamic modification of a desktop layout according to claim 8, further comprising:
a distinguish module configured to distinguish the desktop area into a component area and a widget area, wherein the component area comprises an information area and a rolling area, the components comprise information components and desktop components,
wherein the layout module is further configured to place the information components on the information area, and to place the desktop components on the rolling area.

10. The system for dynamic modification of a desktop layout according to claim 9, wherein:
the desktop components are stored desktop components; and
the layout module is further configured to place the stored desktop components in a specified position on a specified page in the rolling area.

11. The system for dynamic modification of a desktop layout according to claim 9, wherein when the requests for modifying the components include a request to add a desktop component on the desktop area, the refresh module further comprises:
a component create unit configured to create the desktop component that is to be added;
a place unit configured to place the added desktop component on the rolling area;
an information obtain unit configured to obtain data of a widget initiated by the added desktop component that has been successfully placed, and to send data of the widget initiated by the added desktop component to the widget area; and
a widget create unit configured to create a widget according to the data in the widget area, and adding the created widget to the widget area.

12. The system for dynamic modification of a desktop layout according to claim 11, wherein the place unit is further configured to obtain a size of the desktop component that is to be added; to travel the rolling area and existing desktop components, to obtain coordinates of vertexes of the existing desktop components and the rolling area; to place a top left vertex of the added desktop component to a respective vertex in the rolling area that has been gone through; to travel all the desktop components to determine whether the placed desktop component is overlapping the existing desktop components; to travel another vertex if the placed desktop component is determined to overlap the existing desktop components; and to place the added desktop component in the rolling area on a position that would have no overlapping with the existing desktop components if the placed desktop component is determined to not overlap with the existing desktop.

13. At least one non-transitory computer storage medium having instructions stored thereon that, when executed by a computer, cause the following process to be performed:
obtaining desktop elements;
placing the desktop elements on a desktop area;
receiving requests for modifying the desktop elements on the desktop area; and
modifying the desktop elements on the desktop area according to the requests for modifying.

14. The computer storage medium according to claim 13, wherein the desktop elements comprise components and widgets, and the process comprises:
obtaining components and widgets;
placing the components and the widgets on the desktop area;
receiving requests for modifying the components on the desktop area;
modifying the components and the widgets on the desktop area according to the requests for modifying.

15. The computer storage medium according to claim 14, wherein:
before the step of obtaining the components and the widgets, the process comprises distinguishing the desktop area into a component area and a widget area, wherein the component area comprises an information area and a rolling area, the components comprise information components and desktop components; and
the step of placing the components and the widgets on the desktop area comprises placing the information components on the information area, placing the desktop components in the rolling area, and placing the widgets on the widget area.

16. The computer storage medium according to claim 15, wherein the desktop components are stored desktop components, the step of placing the components and the widgets on the desktop area comprises placing the stored desktop components in a specified position on a specified page in the rolling area.

17. The computer storage medium according to claim 15, wherein when the requests for modifying the components include a request to add a desktop component on the desktop area, the step of modifying the components and the widgets on the desktop comprises:
creating a desktop component that is to be added;
placing the added desktop component on the rolling area;
obtaining data of a widget initiated by the added desktop component that has been successfully placed, and sending data of the widget initiated by the added desktop component to the widget area; and
creating a widget according to the data in the widget area, and adding the created widget to the widget area.

18. The computer storage medium according to claim 17, wherein the step of placing the added desktop component on the rolling area comprises:
obtaining a size of the desktop component that is to be added;
travelling the rolling area and existing desktop components, obtaining coordinates of vertexes of the existing desktop components and the rolling area;
placing a top left vertex of the added desktop component to a respective vertex in the rolling area that has been gone through; and
travelling all the desktop components to determine whether the placed desktop component is overlapping the existing desktop components, travelling another vertex if the placed desktop component is determined to overlap the existing desktop, and placing the added desktop component in the rolling area on a position that would have no overlapping with the existing desktop components if the placed desktop component is determined to not overlap with the existing desktop.
